(19) United States
(12) Patent Application Publication
(10) Pub. No.: US 2018/0287920 A1
(43) Pub. Date: Oct. 4, 2018

(54) INTERCEPTING APPLICATION TRAFFIC MONITOR AND ANALYZER

(71) Applicant: CA, Inc., New York, NY (US)

(72) Inventor: Jayanth Sanganabhatla, Hyderabad (IN)

(21) Appl. No.: 15/474,477

(22) Filed: Mar. 30, 2017

(51) Int. Cl. H04L 12/26; H04L 29/06; H04L 29/08

(52) U.S. Cl. CPC H04L 43/0876; H04L 67/42; H04L 43/062; H04L 67/28; H04L 67/303

(57) ABSTRACT

A web data collection and analysis system leveraging an intermediary allows for monitoring application traffic and usage patterns without deploying monitoring and analysis code to each application. Since the monitoring and analysis code is decoupled from the application, the system can also monitor and analyze legacy applications that may not be compatible with current web analytic tools. As application requests pass through the proxy server, an application traffic monitoring engine collects data from the web requests and responses. An application analytics engine analyzes the collected data and generates reports based on the analysis. The application traffic monitoring engine continually updates the collected application data as additional application traffic flows through the system. As a result, the system reflects a current status of the application traffic and usage pattern based on the flow of application requests and responses.

### BACKGROUND

The disclosure generally relates to the field of data processing, and more particularly to web monitoring and analytics systems.

Web analytics is the collection, analysis and reporting of data related to web traffic and usage patterns. Web analytics is an increasingly important aspect of modern computing. Organizations are relying on insights derived from web analytics to aid in decision-making, identify cost reduction opportunities, market research, etc. As the impact and importance of web data analysis affect an organization's growth and/or day to day operations, organizations are devoting considerable resources to gathering and analyzing data.

### BRIEF DESCRIPTION OF THE DRAWINGS

Aspects of the disclosure may be better understood by referencing the accompanying drawings.

FIG. 1 depicts an example topology of an application collection and analysis system.

FIG. 2 is a flowchart of example operations for intercepting and analyzing application request traffic.

FIG. 3 is a flowchart of example operations for intercepting and analyzing application response traffic.

FIG. 4 is a flowchart of example operations depicting the analysis of application requests and responses and generation of an application analytics report(s) based on the analysis.

FIG. 5 depicts an example computer system with a proxy server configured to intercept and analyze application traffic and usage data.

### DESCRIPTION

The description that follows includes example systems, methods, techniques, and program flows that embody aspects of the disclosure. However, it is understood that this disclosure may be practiced without these specific details. For instance, this disclosure refers to a proxy server in illustrative examples. Aspects of this disclosure can be also applied to a gateway or router. In other instances, well-known instruction instances, protocols, structures, and techniques have not been shown in detail in order not to obfuscate the description.

Introduction

Collecting information for web analytics can be done by analyzing web server log files and page tagging. Analyzing web server log files involves parsing the web server logs and processing the collected information. Page tagging involves embedding code in a web page. The embedded code tags a visitor with a cookie and sends data back to a server for processing. Data collected from web server log files may not accurately reflect client traffic because web server log files include spider traffic from search engines. Embedding code to each web page can become cumbersome and time consuming with the increasing complexity of websites and size of websites.

Overview

A web data collection and analysis system leveraging an intermediary allows for monitoring application traffic and usage patterns without deploying monitoring and analysis code to each application. Since the monitoring and analysis code is decoupled from the application, the system can also monitor and analyze legacy applications that may not be compatible with current web analytic tools and allows adaptation/implementation of newer tools. As application requests pass through the proxy server, an application traffic monitoring engine collects data from the application requests and responses. An application analytics engine analyzes the collected data and generates reports based on the analysis. The application traffic monitoring engine continually updates the collected application data as additional application traffic flows through the system. As a result, the system reflects a current status of the application traffic and usage pattern based on the flow of application requests and responses.

Example Illustrations

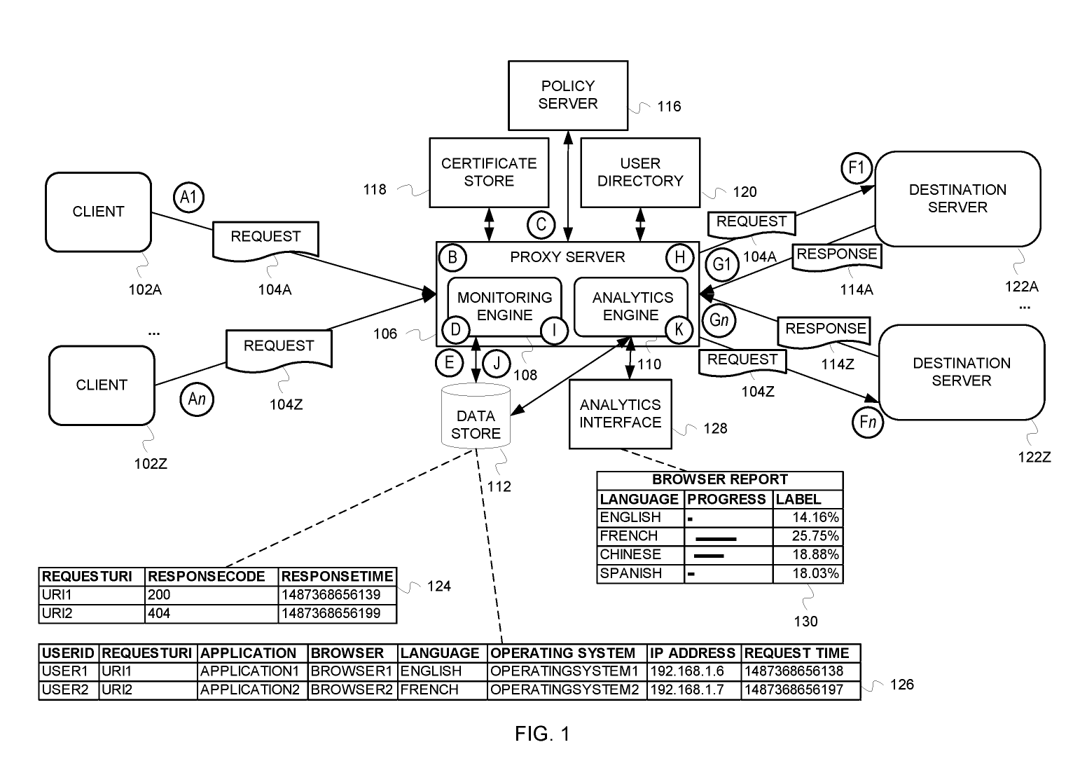

FIG. 1 depicts an example topology of an application collection and analysis system. FIG. 1 includes a number of clients 102A through 102Z (“clients 102”) sending application requests to destination servers 122A through 122Z (“destination servers 122”) through a network. The application requests are intercepted by a proxy server 106 which comprises an application traffic and usage monitoring engine 108 (hereinafter “monitoring engine 108”) and an application traffic and usage analytics engine 110 (hereinafter “analytics engine 110”). The proxy server 106 can access a data store 112 and an analytics interface 128. In addition, the proxy server 106 can access a certificate store 118 and a user directory 120 and communicate with a policy server 116.

FIG. 1 is annotated with a series of letters A (A1-An)-F (F1-Fn)-G (G1-Gn)-K. These letters represent stages of operations. Although these stages are ordered for this example, the stages illustrate one example to aid in understanding this disclosure and should not be used to limit the claims. Subject matter falling within the scope of the claims can vary with respect to the order and some of the operations.

Prior to stage A1, the proxy server 106 begins listening for requests submitted for the destination servers 122. The proxy server 106 listens based on settings (e.g., proxy server name, port of the proxy server, etc.). At stage A1, the client 102A sends an application request 104A to an application hosted on the destination servers 122. The application request 104A sent to the application hosted by the destination servers 122 may indicate an operation to be performed, parameters to be used in performing the operation, and a name of the application. The application request 104A may also include information regarding the client and/or user (e.g., a cookie). The proxy server 106 and/or the destination servers 122 may use the information to identify, authorize and/or authenticate the requestor making the application request 104A. In the same or overlapping period of time at stage A2, another client depicted as client 102Z sends an application request 104Z to a different application hosted by the destination servers 122.

At stage B, the proxy server 106 detects the application request 104A sent by the client 102A. The proxy server 106 may assign an application request identifier to the detected application request 104A. At stage C, the proxy server 106 communicates with the user directory 120 and the policy server 116 to authenticate and authorize the client 102A. After authorizing and authenticating the client 102A, the proxy server 106 creates a session for the application request 104A. The session may be represented by a session object and assigned a unique session identifier. The session object is a data structure that contains the properties of the application request 104A (e.g., a session identifier, a cookie identifier, an application identifier, a client identifier, etc.). The proxy server 106 communicates the application request 104A to the monitoring engine 108.

At stage D, the monitoring engine 108 determines information to capture from the application request 104A (e.g., in a start line, a header, and a body). The monitoring engine 108 reads configuration data, e.g., in a file, that define which information to capture from an application request 104A. The information specified to be captured from the application request facilitates the monitoring and analysis of traffic and usage for an application. Thus, the captured information, both individually and collectively, is generally referred to herein as application traffic and usage data. To access information contained in the application request 104A, the monitoring engine 108 may communicate with the user directory 120, the policy server 116, and/or the certificate store 118 through the proxy server 106. For example, if the application request 104A is an HTTP Secure (HTTPS) request, the proxy server 106 communicates with the certificate store 118 to download and install certificates associated with the application request 104A. This allows the monitoring engine 108 to decrypt the application request 104A and capture the desired information contained in the application request 104A. The monitoring engine 108 determines the information in the application request 104A indicated in a configuration file or settings of the monitoring engine 108. Examples of the information that may be specified for capture include application request information such as a request date and time, request header, request uniform resource identifier (URI), operation to be performed; client profile information such as client internet protocol (IP), browser information (e.g., name, type, browser language preference, etc.), client operating system information (e.g., operating system name, operating system type, etc.) information about a client device (e.g., device manufacturer, device type, etc.), geographical information about a client (e.g., country, region, city, etc.), internet service provider (ISP); information about a user such as user identifier, a role(s) and/or group(s) the user is a member, etc.

At stage E, the monitoring engine 108 stores the captured application traffic and usage data in the data store 112. The monitoring engine 108 stores the application traffic and usage data by updating an application request table 126 (hereinafter “table 126”). The table 126 contains the application traffic and usage data determined from the application request 104A. If the table 126 does not exist, the monitoring engine 108 creates the table 126 and then performs the update.

At stage F1, the proxy server 106 forwards the application request 104A to a destination server 122A via the network. The proxy server 106 includes the session identifier with the forwarded application request 104A. The destination server 122A processes the application request 104A. At stage G1, the destination server 122A sends an application response 114A to the proxy server 106. The destination server 122A includes the session identifier with the application response 114A. In the same or overlapping period of time at stage G2, a destination server 122Z sends a response 114Z to the proxy server 106 via the network.

At stage H, the proxy server 106 receives the application response 114A from the destination server 122A. The proxy server 106 determines and associates the application response 114A with the session object that is associated with the application request 104A using the session identifier. The proxy server 106 may assign an identifier to the application response 114A. The proxy server 106 communicates the application response 114A to the monitoring engine 108. At stage I, the monitoring engine 108 examples the application response 114A to capture (i.e., record) the application traffic and usage data in the application response 114A specified for recording or capturing. Examples of the data to capture from the application response includes the response code, the session identifier, the application request URI, response date and time, etc.

At stage J, the monitoring engine 108 stores the application traffic and usage data from the application response 114A in the data store 112. For example, the monitoring engine 108 updates an application response table 124 (hereinafter “table 124”). If the table 124 does not exist, the monitoring engine 108 creates the table 124 and then performs the update.

At stage K, the analytics engine 110 retrieves the application traffic and usage data from the data store 112 to generate a browser report 130 to be displayed by the analytics interface 128. The analytics engine 110 may be configured to generate cumulative or otherwise aggregated metrics such as averages, maximum, minimum application traffic and usage metric values from multiple application requests and/or responses. The analytics engine 110 may also aggregate application traffic and usage metric value per application server. The analytics engine 110 may be configured to display individual application traffic and usage metric values such as per client, per destination server, per user name, location, identifier, per application, and/or per application traffic or per usage metric type, etc. For example, the analytics engine 110 can compute the latency of the application response 114A based on the application request 104A date and time and the application response 114A date and time. The analytics engine 110 may also be configured to receive requests to generate and/or update a report(s) from the analytics interface 128. The requests may be made by interacting and/or initiating the request through the analytics interface 128 for example. The requests may also be automated requests by the analytics engine 110 for updates of application traffic and usage reports such as periodic and/or real-time application traffic and usage reports.

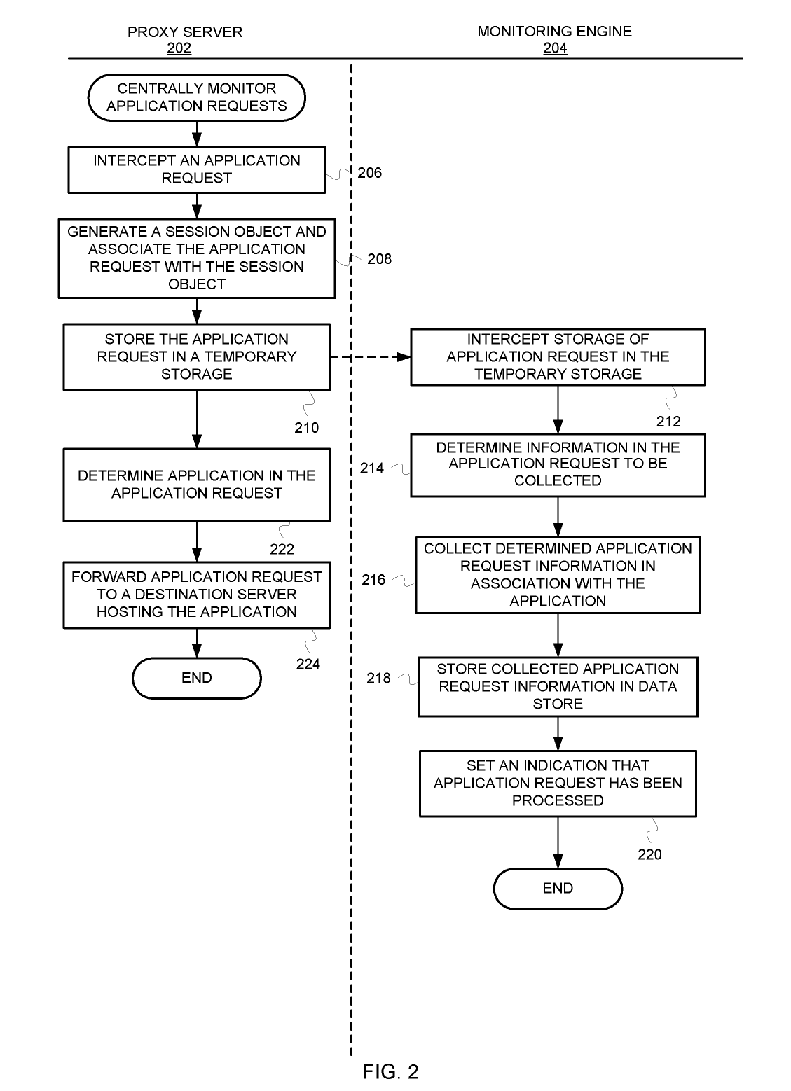

FIG. 2 is a flowchart of example operations for intercepting and analyzing application request traffic. The description in FIG. 2 refers to a proxy server (202), and a monitoring engine (204) performing the example operations for consistency with FIG. 1. The proxy server (202) and the monitoring engine (204) are part of a system that leverages an intermediate position for visibility into requests from various clients to various applications. The monitoring engine 204 collects information in the application request (e.g., contents of a request line, header, and message body) detected by the proxy server 202 and stores the collected information for application specific analysis.

Prior to the operations in, FIG. 2, the proxy server 202 has been configured to listen for application requests from clients based on settings in a configuration file. Other techniques are possible to allow the proxy server 202 to start receiving application requests. Examples of these other techniques include modifying the proxy settings in the client's registry file, setting the clients' web browser to point to the proxy server 202, and modifying switches or routers to intercept application requests and direct them to the proxy server 202. In yet another example, a domain name server (DNS) entry is set to point to the proxy server 202 instead of the destination servers. Several clients may send an application request to one application or several applications. An application can be hosted by one or more destination server. A destination server can host more than one application.

The proxy server 202 intercepts an application request from a client (206). The proxy server 202 can intercept application requests from various clients to various applications. The application request includes a start or request line that contains the name of the application and the operation or method to be performed by the application. The application request also comprises a header and message body. The header contains attributes of the application request. The optional message body may contain data (e.g., images, plain text, video, etc.) to be used in performing the application request. The proxy server 202 may authenticate and/or authorize the user associated with the application request.

The proxy server 202 generates a session object and associates the application request to the session object (208). The proxy server 202 keeps track of the application requests through the session object. The proxy server 202 may use a database, a filesystem, a hash map, etc. to keep track of the session objects. The proxy server 202 may maintain a separate database, table, filesystem or hash maps of session objects per application. The proxy server 202 generates a unique session object identifier for each application request. The proxy server 202 associates the application request to the session object by adding the application request identifier and/or an identifier of the client that initiated the application request to the session object. The unique session object identifier may be a hash of a tuple combination such as a hash of the application request URI and time stamp. The session object identifier may be a globally unique identifier (GUID). The session object identifier is unique among the session object identifiers within the application domain or among various applications. The session object may also contain other information such as a timestamp when the application request was received by the proxy server 202, status (e.g., “in-process,” completed, etc.) of the application request, etc.

The proxy server 202 stores the application request in a temporary storage or cache (210). Caching the application request allows the monitoring engine 204 to collect, and store information from the application request to a data store while the proxy server 202 continues to process other application requests and/or application responses. The temporary storage or cache may be in-memory or disk based. To save space, the proxy server 202 can compress the application request before caching. The proxy server 202 may store the application request using a first-in, first-out method, priority queue, etc. By default, the proxy server 202 follows the caching directive when storing the application message to a cache or temporary storage. The proxy server 202 may determine the cache directive of the application request (e.g., an HTTP header caching directive is set to Private, No-Cache or No-Store). If the cache directive of the application request header indicates that the application should not be cached or stored, then the proxy server 202 communicates the application request to the monitoring engine 204. In another implementation, the proxy server 202 retrieves and communicates the contents of the application request (e.g., request line, header, message body) to the monitoring engine 204. The proxy server 202 may communicate by way of communication protocols (e.g., Transmission Control Protocol/Internet Protocol (TCP/IP), User Datagram Protocol (UDP), file transfer protocol (FTP), etc. The proxy server 202 may also communicate the application request identifier and/or the timestamp to the monitoring engine 204.

The proxy server 202 may also determine if the application request is encrypted. If the proxy server 202 determines that the application request is encrypted, the proxy server 202 may retrieve certificates associated with the application request from a certificate store. The proxy server 202 may store the certificates in the temporary storage with the application request and communicate a location identifier to the monitoring engine 204. In another example, the proxy server 202 communicates the certificates to the monitoring engine 204.

After storing the application request in the temporary storage or cache, the proxy server 202 determines the application in the application request (222). The proxy server 202 parses the application request line to determine the application. The request line comprises of the method to be performed on a resource identified by the URI, the URI which identifies the application or resource upon which to apply the application request, and a protocol version. For example, the request line may look like:

GET http://destination-server-name/application-name HTTP/1.1.

After determining the application name, the proxy server 202 determines a corresponding IP address for the application. The proxy server 202 may maintain an application list that contains the application names and corresponding IP addresses of the destination server(s) that hosts the application. In another implementation, the proxy server 202 may communicate with a directory, DNS in identifying the IP address of the destination server.

The proxy server 202 forwards the application request to a destination server hosting the application (224). The proxy server 202 transforms the request line of the application request using the IP address instead of the name of the destination server and application name. The proxy server 202 then forwards the application request with the session object identifier.

After storing the application request in the temporary storage or cache, the monitoring engine 204 detects the storage of the application request in the temporary storage as indicated by a dashed line (212). The monitoring engine 204 may have an agent that polls the cache or temporary storage for application requests to be processed. In another implementation, the proxy server 202 may set an indication that an application request has been put in the cache or the temporary storage. For example, the proxy server 202 may invoke the monitoring engine 204 and communicate a location identifier of the cache or temporary storage. In another example, the proxy server 202 may set a flag, marker or another type of indicator to denote that an application request was stored in the cache or temporary storage and communicate the indicator to the monitoring engine 204.

The monitoring engine 204 determines the information in the application request to be collected (214). As stated earlier, the monitoring engine 204 may use various means to determine the information to be collected from the application request such as using a properties or configuration file, through setter functions, a pre-defined list, etc. The configuration file, the setter functions, and the pre-defined list may be configured and/or updated by an administrator based, in part, on the application or an application type and/or an application request type. The properties or configuration file may also be generated based, at least in part, on the application request and/or the application. For example, geolocation information is collected for social networking applications but not for financial applications.

After determining the information in the application request to be collected, the monitoring engine 204 collects the determined information in association with the application (216). The monitoring engine 204 collects or capture the determined information using a filter(s). The monitoring engine 204 may also use a getter function(s) to collect the information. If the application request is encrypted, the monitoring engine 204 may retrieve the certificates from the temporary storage or communicate with the certificate store through the proxy server 202 to retrieve the certificates for decrypting the application request. The monitoring engine 204 may also extract user information from a cookie(s) associated with the application request. In another example, the monitoring engine 204 may communicate with an active directory (AD), user directory, lightweight directory access protocol (LDAP), active directory federation services (ADFS), etc. to determine user information based on a user identifier contained in the cookie(s) or the application request.

The monitoring engine 204 may load the collected information in a data structure such as a hash map, array list, etc. The hash map might look something like: Map <String, Object>, wherein the String parameter contains the name or identifier of the collected information and the Object parameter contains the collected information. The monitoring engine 204 may evaluate and/or transform the information. For example, the monitoring engine 204 may transform the timestamp into a DATETIME format.

The monitoring engine 204 stores the collected information from the application request in a data store (218). The collected information may be stored in a relational table (i.e., an application request table) as depicted in FIG. 1. The application request table may be generated and updated by the monitoring engine 204 according to a pre-defined schema if the application request table does not yet exist. In another implementation, a different application request table may be maintained for each application or application type. The information collected from one application request may be inserted as a row in the application request table. Each row is then associated with the application by adding the application identifier. Other information such as DATETIME, destination server IP address may also be stored in the application request table.

After collecting the information from the application request, the monitoring engine 204 sets an indication that the application request has been processed (220). The monitoring engine 204 updates the status indicator of the session object associated with the application request to denote that the monitoring engine 204 has finished processing the application request (i.e., application traffic and usage data from the request has been collected and stored). For example, the monitoring engine 204 may set the indicator to “request processed.”

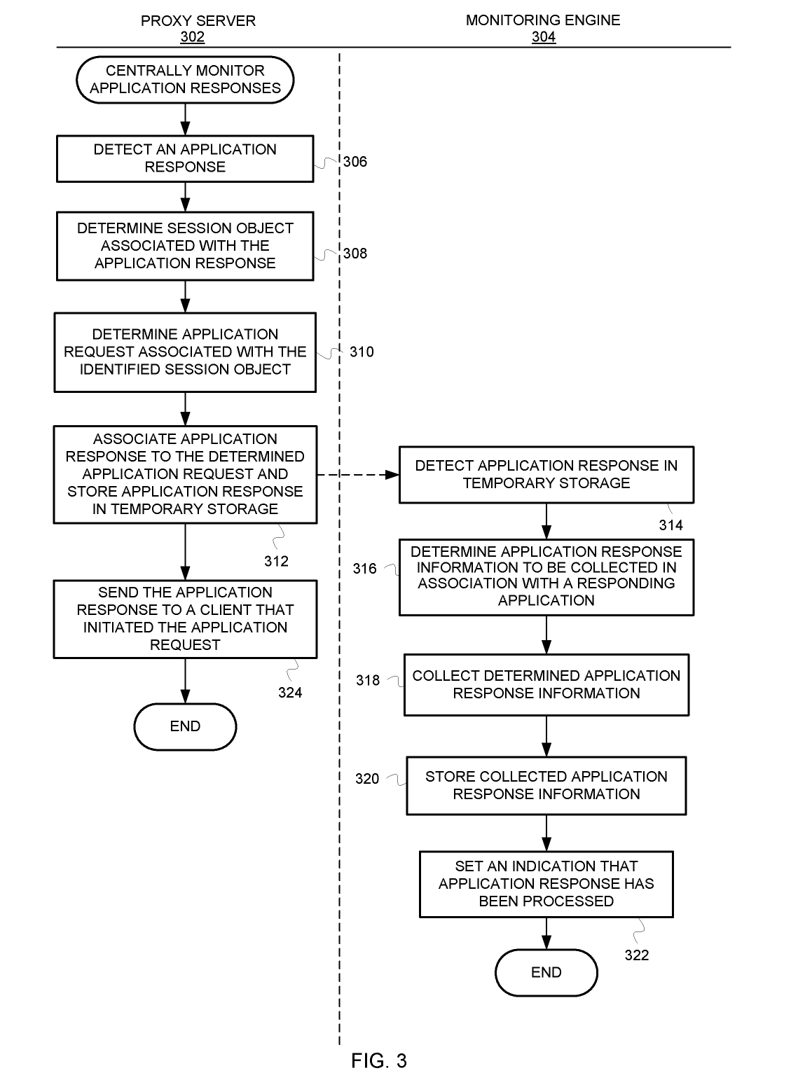

FIG. 3 is a flowchart of example operations for intercepting and analyzing application response traffic. The description in FIG. 3 refers to a proxy server (302), and a monitoring engine (304) performing the example operations for consistency with FIG. 1. The proxy server (302) and the monitoring engine (304) are part of a system that leverages an intermediate position for visibility into requests from various clients to various applications. The monitoring engine 304 collects information in the application response (e.g., contents of a start line, header, and message body) detected by the proxy server 302 and stores the collected information for application specific analysis.

Prior to the operations in, FIG. 3, the proxy server 302 has been configured to listen to application responses from application servers based on settings in a configuration file. Other techniques are possible to allow the proxy server 302 to start receiving application requests such as modifying the proxy settings in the application server's registry file. In another example, switches or routers may be modified to intercept application responses and direct them to the proxy server 302.

The proxy server 302 intercepts an application response (306). The application response comprises a status line, a header, and message body. The status line contains a status code and associated textual phrase. The header contains attributes of the application response such as a session object identifier from the earlier received application request. The optional message body may contain data (e.g., images, plain text, video, etc.) requested by an application request.

The proxy server 302 determines a session object associated with the application response using the session object identifier (308). The proxy server 302 may parse the application response header to determine the session object identifier. The proxy server 302 then queries a database, a file system, or a hash map to determine the session object associated with the application response. The database, file system or hash map is maintained by the proxy server 302 to keep track of session objects. The proxy server 302 may include an application name and/or identifier with the session object identifier in the query. The proxy server 302 generates a unique application response identifier and associates the application response identifier to the session object and the application request by adding the application response identifier to the session object. The proxy server 302 may also update the other information in the session object such as the status of the application request. The status may be determined by the proxy server 302 from the start line of the application response.

After determining the session object, the proxy server 302 determines the application request associated with the session object (310). The proxy server 302 retrieves the application request identifier from the session object. The proxy server 302 associates the determined application request to the application response by adding a URI of the application request or the application request identifier to the application response header as an attribute for example.

The proxy server 302 stores the application response in a temporary storage or cache (312). Caching the application responses allows the monitoring engine 304 to collect, capture and store information from the application response to a data store while the proxy server 302 continues to process other application responses and/or application requests. By default, the proxy server 302 follows the caching directive when storing the application message to a memory cache or temporary storage. The proxy server 302 may determine the cache directive of the application response. If the cache directive of the application response header indicates that the application should not be cached or stored, then the proxy server 302 communicates the application response to the monitoring engine 304. In another implementation, the proxy server 302 retrieves and communicates the contents of the application response (e.g., request line, header, message body) to the monitoring engine 304.

The proxy server 302 may also determine if the application response is encrypted. If the proxy server 302 determines that the application response is encrypted, the proxy server 302 may retrieve certificates associated with the application response from a certificate store if the certificates have not been retrieved earlier during the processing of the associated application request. The proxy server 302 may store the certificates in the temporary storage with the application response and communicate a location identifier to the monitoring engine 304. In another example, the proxy server 302 communicates the certificates to the monitoring engine 304.

After storing the application response in the temporary storage or cache, the proxy server 302 sends the application response to the client that initiated the application request (324). The proxy server 302 identifies the client by retrieving a client identifier from the session object. The proxy server 302 updates the status in the session object and/or the application request.

After the proxy server stored the application response in the temporary storage or cache, the monitoring engine 304 detects the storage of the application response in the temporary storage or the cache as indicated by a dashed line (314). The monitoring engine 304 may have an agent that polls the cache or temporary storage for application responses to be processed. In another implementation, the proxy server 302 may set an indication that an application response has been put in the cache or the temporary storage. For example, the proxy server 302 may set a flag, marker or another type of indicator to denote that an application response was stored in the cache or the temporary storage for processing by the monitoring engine 304. The monitoring engine 304 updates the indicator after processing the application response to denote to the proxy server 302 that the application response contained in the cache or temporary storage has been processed.

The monitoring engine 304 determines the information in the application response to be collected (316). As stated earlier, the monitoring engine 304 may use various means to determine the information to be collected such as using a properties or configuration file, through setter functions, a pre-defined list, etc. The properties or configuration file, the setter functions, and the pre-defined list may be configured and/or updated by an administrator based, in part, on the application or an application type and/or an application response. The properties or configuration file may also be generated based, at least in part, on the application response and/or the application.

After determining the information in the application response to be collected, the monitoring engine 304 collects the determined information in association with the application (318). The monitoring engine 304 collects or capture the determined information using at least one filter for example. The monitoring engine 304 may also use getter function(s) to collect the information. If the application response is encrypted, the monitoring engine 304 may retrieve the certificates from the temporary storage or communicate with the certificate store through the proxy server 302 to retrieve the certificates for decrypting the application response. The monitoring engine 304 may also extract user information from a cookie(s) associated with the application response. In another example, the monitoring engine 304 may communicate with an active directory (AD), user directory, lightweight directory access protocol (LDAP), active directory federation services (ADFS), etc. to determine user information based on a user identifier contained in the cookie(s) or the application response.

The monitoring engine 304 may load the collected information in a data structure such as a hash map, array list, etc. The hash map might look something like: Map <String, Object>, wherein the String parameter contains the name or identifier of the collected information and the Object parameter contains the collected information. The monitoring engine 304 may evaluate and/or transform the information. For example, the monitoring engine 304 may transform the timestamp into a DATETIME format.

The monitoring engine 304 stores the collected information in association with the application in a data store (320). The collected information may be stored in a relational table (i.e., an application response table) as depicted in FIG. 1. The application response table may be generated and updated by the monitoring engine 304 according to a pre-defined schema if the application response table does not yet exist. The application response table may contain information from application responses processed by the monitoring engine 304. Further, a different application response table may be maintained for each application or application type. The information collected from one application response may be inserted in a row in the application response table. Each row may be associated with an identifier of the responding application or associated application request identifier or application request URI by adding the identifiers or application request URI to the row. Other information such as DATETIME, application IP address may also be stored in the application response table.

After collecting the information from the application response, the monitoring engine 304 updates an indication in the session object that the application response has been processed (322). The monitoring engine 304 updates the status indicator of the application response to denote that the monitoring engine 304 has finished processing the application response (i.e., application traffic and usage data from the application response has been collected and stored) and the proxy server 302 may transmit the application response to the client. For example, the monitoring engine 304 may set the indicator to “response processed.”

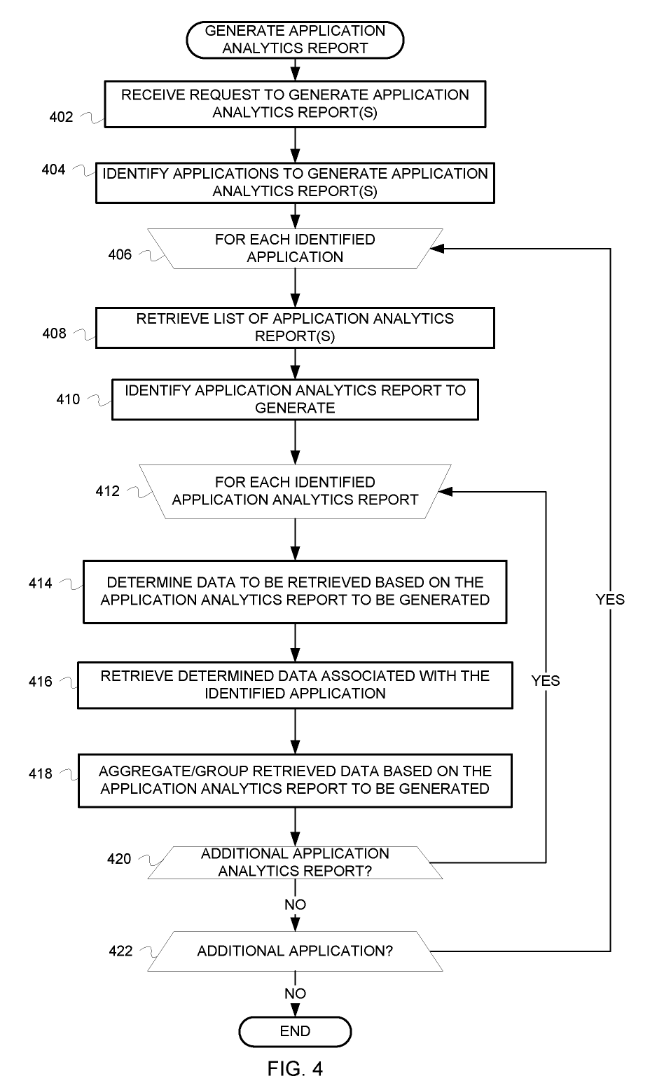

FIG. 4 is a flowchart of example operations depicting the analysis of application requests and responses and generation of an application analytics report(s) based on the analysis. The description in FIG. 4 refers to an analytics engine performing the example operations for consistency with FIG. 1. The analytics server is part of a system that leverages an intermediate position for visibility into requests from various clients to various applications and responses from various applications to various clients.

The analytics engine receives a request to generate an application analytics report (402). The request may be received from a method or function call, an API request, user interface, etc. The request to generate an application analytics report may also be generated periodically. The request also includes a list of applications to generate the application analytics report for.

The analytics engine identifies the application(s) to generate an application analytics report indicated in the received request (404). Identifying the application(s) may be no more than reading identifying information from the list of applications. Each application is identified by a unique identifier such as an application identifier, a URI, an application name, an IP address, etc.

Blocks 408 to 418 depict example operations for generating application analytics report for an application. The analytics engine begins to analyze the identified application(s) in the application list (406). The analytics engine can traverse the application list as structured, or rearrange the list of applications depending on various factors. The arrangement may be based on the order of the identifying information, type of application, etc. The description will refer to an application being processed as the “selected application.”

The analytics engine retrieves a list of application analytics report to generate for the selected application (408). The request may be to generate a specific type of application analytics report, such as a report on a number of application hits per geographic location. The request may also be to generate more than one application analytics report. Different types of application analytics report may be generated for an application and/or application types. For example, an application analytics report on application hits based on geographic location may be generated for social network applications, whereas an application analytics report based on the latency of responses may be generated for financial applications. The request may also generate default application analytics report(s) for each application if the request does not specify the application analytics report(s) to be generated.

The analytics engine identifies the application analytics report to be generated in the retrieved list of application analytics reports (410). Identifying the application analytics report(s) may be no more than reading identifying information from the retrieved list of application analytics reports. Each application analytics report may be identified by a unique identifier such as an application analytics report identifier, an application analytics report name for example.

The analytics engine begins to analyze the identified application analytics report in the list (412). The analytics engine can traverse the list of application analytics report(s) as structured, or rearrange the list of application analytics report(s) depending on various factors. The arrangement may be based on the order of the identifying information, type of application analytics report, etc. The description will refer to an application being processed as the “selected application analytics report.”

The analytics engine determines data to be retrieved based on the application analytics report to be generated (414). The analytics engine may use various means to determine the data to be retrieved such as using a pre-defined list or identified in a structured query language (SQL) query. The pre-defined list or SQL query may be configured and/or updated by an administrator based, in part, on the application analytics report or an application type. The pre-defined list or SQL query may also be generated based, at least in part, on the application and/or the application type.

The analytics engine retrieves the determined data associated with the identified application (416). The determined data may be retrieved from a data store by performing a query based on the application identifier. The determined data may be retrieved based on a particular time period. The time period may be determined based on a timestamp. For example, the analytics engine may retrieve the browser language of the application hits over a specified time period.

The analytics engine aggregates or groups the retrieved data based on the analytics report to be generated (418). The analytics engine aggregates the individual pieces of data retrieved. Aggregation may be a summation of the individually retrieved data. The aggregation may be represented as a percentage of the total number of retrieved data, based on a percentage of a total number of retrieved data for a particular time period and/or based on a combination of factors. The aggregated data may also be grouped based on a certain criterion. For example, a number of application hits using an English browser or Spanish browser may be aggregated. The aggregated data are then grouped alphabetically according to the browser language. The analytics engine may then determine the percentage of application hits based on the browser language.

The application analytics report example in FIG. 1 showed the percentages of application hits per browser language. The application analytics report may show other application traffic and/or usage such as application hits per application type, geographic location, operating system, per user, etc. The application analytics report may also show the percentage of error generated per application, a summary of application response delays, application link analysis, etc.

The application analytics report can be generated to show performance based on various application analytics metrics. A metric can be defined as a measure of a specific application activity in a given time interval (e.g., execution time, error rate, etc.). For example, an application request date and time and an application response date and time is used to determine the latency of the application response. The latency can be compared to pre-established criteria to determine if the latency is within bounds.

The application analytics report can be generated by application category. For example, a report on what application categories (e.g., social networking applications, database applications, etc.) are getting requests per particular time period. The report may be organized at an organization level. For example, an application analytics report can be generated for applications deployed within the organization. The organization can use this report to analyze whether certain applications are being used by the organization's employees. In another example, an organization can monitor employee productivity by intercepting requests to social networking applications during work hours. The organization may set a threshold of zero requests for social networking applications during work hours. If the threshold is exceeded (e.g., multiple requests for social networking applications have been detected during work hours), the analytics engine may be programmed to perform actions in response to the determination such as identifying the employees accessing the social networking applications and/or determining how the employees are accessing the social networking applications (e.g., desktop, mobile device, etc.), and sending a notification to an administrator and/or filtering the requests to the social networking applications.

A determination of what type of application analytics report may be made. For example, an application analytics report can be based on an application category, per client and/or user, and/or groups of clients and/or users. In another example, an administrator can configure the contents and/or the format of the application analytics report(s), such as whether the application analytics report is displayed in a user interface, saved in a file, displayed using a tabular format or as a spreadsheet, etc. In another example, a configuration file can be used to determine the type and contents of the application analytics report to be generated and/or displayed.

The analytics engine determines if there is additional application analytics report to be generated (420). If there is an additional application analytics report to be generated, then the next application analytics report is selected (412). If there is no additional application analytics report to be generated, then the analytics engine determines if there is an additional application to be processed (422). If there is an additional application to be processed, then the next application is selected (406). If there is no additional application to be processed, then the process ends.

Variations

The examples refer to a system leveraging a proxy server for visibility into application requests and responses. A system may also leverage other intermediaries such as a gateway, an agent configured to intercept application requests and responses. The agent may be deployed in a server and switches and/or routers may be modified to route inbound and outbound traffic through the agent. In yet other implementations, more than one intermediary (e.g., proxy server, gateway) may be deployed in a network to monitor the application(s) traffic and usage data.

The examples refer to session objects to keep track of application requests and responses. Other techniques such as using cookies, request identifiers, time stamps, etc. may be used to track application requests and responses instead.

The examples refer to a data store for storing the information collected from application requests and responses. The collected information may be stored in a file, record, data structure, etc. Custom fields may be added such as request headers, response headers, etc. prior to storage.

The examples often refer to an “engine.” The engine is a construct used to refer to the implementation of functionality for monitoring application traffic and usage data. This construct is utilized since numerous implementations are possible. The term is used to efficiently explain the content of the disclosure. Although the examples refer to operations being performed by an engine, different entities can perform different operations.

The flowcharts are provided to aid in understanding the illustrations and are not to be used to limit the scope of the claims. The flowcharts depict example operations that can vary within the scope of the claims. Additional operations may be performed; fewer operations may be performed; the operations may be performed in parallel; and the operations may be performed in a different order. For example, the operations depicted in blocks 218 and 220 can be performed in parallel or concurrently. It will be understood that each block of the flowchart illustrations and/or block diagrams, and combinations of blocks in the flowchart illustrations and/or block diagrams, can be implemented by program code. The program code may be provided to a processor of a general-purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine-readable medium may be a machine-readable signal medium or a machine-readable storage medium. A machine-readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine-readable storage medium would include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine-readable storage medium may be any tangible medium that can contain, or store a program for use by or in connection with an instruction execution system, apparatus, or device. A machine-readable storage medium is not a machine-readable signal medium.

A machine-readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a machine-readable storage medium and that can communicate, propagate, or transport a program for use by or in connection with an instruction execution system, apparatus, or device.

Program code embodied on a machine-readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine-readable medium that can direct a machine to function in a particular manner, such that the instructions stored in the machine-readable medium produce an article of manufacture including instructions which implement the function/act specified in the flowchart and/or block diagram block or blocks.

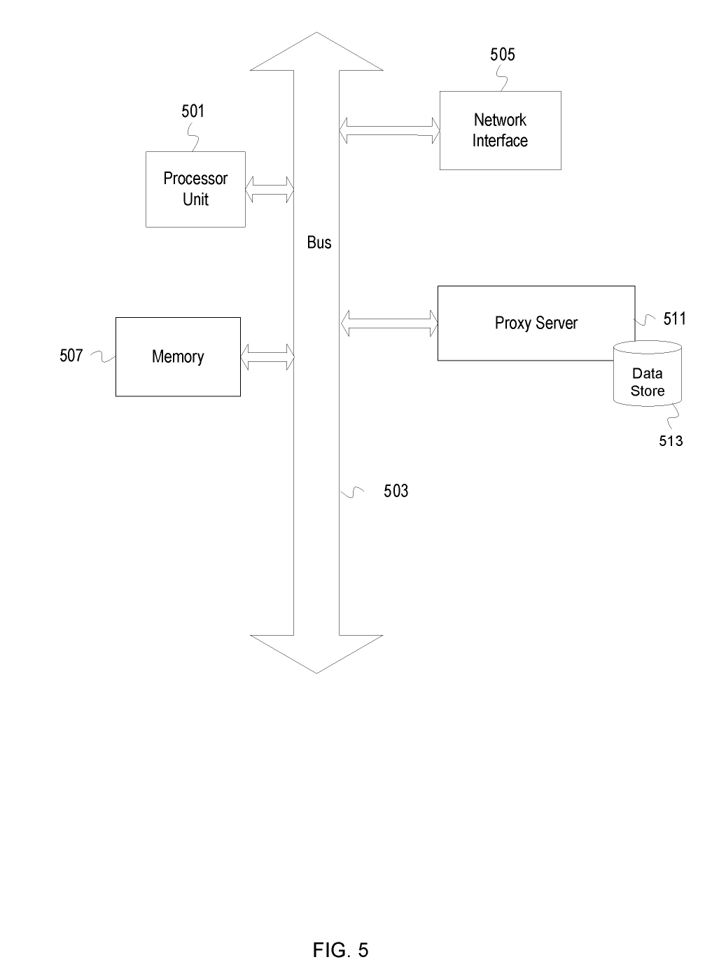

FIG. 5 depicts an example computer system with a proxy server configured to intercept and analyze application traffic and usage data. The computer system includes a processor unit 501 (possibly including multiple processors, multiple cores, multiple nodes, and/or implementing multi-threading, etc.). The computer system includes memory 507. The memory 507 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 503 (e.g., PCI, ISA, PCI-Express, HyperTransport® bus, InfiniBand® bus, NuBus, etc.) and a network interface 505 (e.g., a Fiber Channel interface, an Ethernet interface, an internet small computer system interface, SONET interface, wireless interface, etc.). The system also includes a proxy server 511 and a data store 513. The proxy server 511 intercepts and analyzes application traffic and usage data. Any one of the previously described functionalities may be partially (or entirely) implemented in hardware and/or on the processor unit 501. For example, the functionality may be implemented with an application specific integrated circuit, in logic implemented in the processor unit 501, in a co-processor on a peripheral device or card, etc. Further, realizations may include fewer or additional components not illustrated in FIG. 5 (e.g., video cards, audio cards, additional network interfaces, peripheral devices, etc.). The processor unit 501 and the network interface 505 are coupled to the bus 503. Although illustrated as being coupled to the bus 503, the memory 507 may be coupled to the processor unit 501.

While the aspects of the disclosure are described with reference to various implementations and exploitations, it will be understood that these aspects are illustrative and that the scope of the claims is not limited to them. In general, techniques to intercept and analyze application traffic and usage data as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

Terminology

The description refers to a plug-in engine. An “engine” refers to a program instance that carries a task or tasks dispatched from another program instance that calls, instantiates, or invokes the engine. State information is maintained for the engine to return a task result to the program instance that dispatched the task. A context switch may occur between the dispatching program instance and the engine. Instead of a context switch, the dispatching program instance may maintain information to track the state of the dispatched task and continue performing other operations, such as dispatching another task to the engine or another engine.

As used herein, the term “or” is inclusive unless otherwise explicitly noted. Thus, the phrase “at least one of A, B, or C” is satisfied by any element from the set {A, B, C} or any combination thereof, including multiples of any element.

What is claimed is:

1. A method comprising:
intercepting, at an intermediary between clients and server processes of a plurality of applications, requests that target the plurality of applications;
recording information of the requests to later correlate the requests to responses from the server processes and to analyze the information to determine application traffic and usage data, wherein the recording is based, at least in part, on configuration information;
after recording the information, forwarding the requests to respective ones of the server processes;
based on receipt of responses from the server processes destined for corresponding ones of the clients,
recording information about the responses and then forwarding each of the responses to a corresponding one of the clients;
for each of the responses,
determining a respective one of the intercepted requests based on the previously recorded information of the request and the response;
correlating the recorded information of the response with the recorded information of the respective one of the intercepted requests;
aggregating the correlated information by corresponding ones of the plurality of applications, wherein the recorded information comprises application identifiers; and
deriving application traffic data and application usage data per application based on the aggregated information.

2. The method of claim 1, wherein recording information of the application requests comprises recording client profile information, wherein the client profile information comprises client browser, operating system and geographical information.

3. The method of claim 1 further comprising:
deriving application traffic data and application usage data per application category.

4. The method of claim 1, wherein the request comprises a cookie containing a user identifier for querying user information from a user directory.

5. The method of claim 1, wherein the intermediary is a proxy server.

6. The method of claim 1 further comprising:
determining a number of instances that an application metric has exceeded a threshold size over a period of time; and
in response to determining that a threshold has been exceeded, transmitting a notification that threshold size has been exceeded.

7. The method of claim 1 further comprising:
generating session objects for the requests, wherein a session object indicates at least one property of a request.

8. The method of claim 1 further comprising:
generating a report based on the derived application traffic data and application usage data per application.

9. One or more non-transitory machine-readable media comprising program code to monitor application traffic and usage patterns, the program code to:
intercept, at an intermediary between clients and server processes of a plurality of applications, requests that target the plurality of applications;
record information of the requests to later correlate the requests to responses from the server processes and to analyze the information to determine application traffic and usage data, wherein the record is based, at least in part, on configuration information;
after the information is recorded, forward the requests to respective ones of the server processes;
based on receipt of responses from the server processes destined for corresponding ones of the clients,
record information about the responses and then forward each of the responses to a corresponding one of the clients;
for each of the responses,
determine a respective one of the intercepted requests based on the previously recorded information of the request and the response;
correlate the recorded information of the response with the recorded information of the respective one of the intercepted requests;
aggregate the correlated information by corresponding ones of the plurality of applications, wherein the recorded information comprises application identifiers; and
derive application traffic data and application usage data per application based on the aggregated information.

10. The machine-readable media of claim 9, wherein the program code to record information of the application requests comprises program code to record client profile information, wherein the client profile information comprises client browser, operating system and geographical information.

11. The machine-readable media of claim 9 further comprising program code to derive application traffic data and application usage data per application category.

12. The machine-readable media of claim 9, wherein the request comprises a cookie containing a user identifier to query user information from a user directory.

13. The machine-readable media of claim 9, wherein the intermediary is a proxy server.

14. An apparatus comprising:
a processor; and
a machine-readable medium having program code executable by the processor to cause the apparatus to:
intercept, at an intermediary between clients and server processes of a plurality of applications, requests that target the plurality of applications;
record information of the requests to later correlate the requests to responses from the server processes and to analyze the information to determine application traffic and usage data, wherein the record is based, at least in part, on configuration information;
after the information is recorded, forward the requests to respective ones of the server processes;
based on receipt of responses from the server processes destined for corresponding ones of the clients,
record information about the responses and then forward each of the responses to a corresponding one of the clients;
for each of the responses,
determine a respective one of the intercepted requests based on the previously recorded information of the request and the response;
correlate the recorded information of the response with the recorded information of the respective one of the intercepted requests;
aggregate the correlated information by corresponding ones of the plurality of applications, wherein the recorded information comprises application identifiers; and
derive application traffic data and application usage data per application based on the aggregated information.

15. The apparatus of claim 14, wherein the program code executable by the processor to cause the apparatus to record information of the application requests comprises program code executable by the processor to cause the apparatus to record client profile information, wherein the client profile information comprises client browser, operating system and geographical information.

16. The apparatus of claim 14, wherein the machine-readable medium further comprises program code executable by the processor to cause the apparatus to:
derive application traffic data and application usage data per application category.

17. The apparatus of claim 14, wherein the request comprises a cookie containing a user identifier to query user information from a user directory.

18. The apparatus of claim 14, wherein the program code further comprises program code executable by the processor to cause the apparatus to:
determine a number of instances that an application metric has exceeded a threshold size over a period of time; and
in response to the determination that the threshold size has been exceeded, transmit a notification that the threshold size has been exceeded.

19. The apparatus of claim 14, wherein the program code further comprises program code executable by the processor to cause the apparatus to:
generate session objects for the requests, wherein a session object indicates at least one property of a request.

20. The apparatus of claim 14, wherein the program code further comprises program code executable by the processor to cause the apparatus to:
generate a report based on the derived application traffic data and application usage data per application.
